(19) United States
(12) Patent Application Publication
(10) Pub. No.: US 2015/0036008 A1
(43) Pub. Date: Feb. 5, 2015

(54) Method, Apparatus and Computer Program Product for Image Stabilization

(71) Applicant: Nokia Corporation, Espoo (FI)

(72) Inventor: Pranav Mishra, Bangalore (IN)

(73) Assignee: Nokia Corporation, Espoo (FI)

(21) Appl. No.: 14/385,264

(22) PCT Filed: Mar. 4, 2013
(86) PCT No.: PCT/FI2013/050231

§ 371 Date: Sep. 15, 2014

(30) Foreign Application Priority Data
Mar. 26, 2012 (IN) 1126/CHE/2012

(51) Int. Cl. H04N 5/232

(52) U.S. Cl. CPC H04N 5/23267; H04N 5/23251
USPC 348/208.6

(57) ABSTRACT

In accordance with an example embodiment a method, apparatus and computer program product are provided. The method comprises configuring a pre-determined movement of at least one of a lens element (210) and a sensor element (212). The method further comprises performing the pre-determined movement of the at least one of the lens element (210) and the sensor element (212) during capturing of an image.

### TECHNICAL FIELD

Various implementations relate generally to method, apparatus, and computer program product for image stabilization.

### BACKGROUND

An increasing number of devices are equipped with media capture tools, such as a camera, thereby facilitating an ease of capture of content, such as images. In some exemplary scenarios, an image may be captured in less than ideal conditions. For example, an image of an object may be captured while the object is in motion or an image capture device may not be steady while capturing the image of an object or both. In such scenarios, the captured image may include blurring of content, which may produce a distorting effect on the details included in the image.

### SUMMARY OF SOME EMBODIMENTS

Various aspects of examples of examples embodiments are set out in the claims.

In a first aspect, there is provided a method comprising: configuring a pre-determined movement of at least one of a lens element and a sensor element; and performing the pre-determined movement of the at least one of the lens element and the sensor element during capturing of an image.

In a second aspect, there is provided an apparatus comprising at least one processor; and at least one memory comprising computer program code, the at least one memory and the computer program code configured to, with the at least one processor, cause the apparatus to at least perform: configuring a pre-determined movement of at least one of a lens element and a sensor element; and performing the pre-determined movement of the at least one of the lens element and the sensor element during capturing of an image.

In a third aspect, there is provided an apparatus comprising: a lens element; a sensor element; at least one processor; and at least one memory comprising computer program code, the at least one memory and the computer program code configured to, with the at least one processor, cause the apparatus to at least perform: configuring a pre-determined movement of at least one of the lens element and the sensor element; and performing the pre-determined movement of the at least one of the lens element and the sensor element during capturing of an image.

In a fourth aspect, there is provided a computer program product comprising at least one computer-readable storage medium, the computer-readable storage medium comprising a set of instructions, which, when executed by one or more processors, cause an apparatus at least to perform: configuring a pre-determined movement of at least one of a lens element and a sensor element; and performing the pre-determined movement of the at least one of the lens element and the sensor element during capturing of an image.

In a fifth aspect, there is provided an apparatus comprising: means for configuring a pre-determined movement of at least one of a lens element and a sensor element; and means for performing the pre-determined movement of the at least one of the lens element and the sensor element during capturing of an image.

In a sixth aspect, there is provided a computer program instructions which when executed by an apparatus, cause the apparatus to: configure a pre-determined movement of at least one of a lens element and a sensor element; and perform the pre-determined movement of the at least one of the lens element and the sensor element during capturing of an image.

### BRIEF DESCRIPTION OF THE FIGURES

Various embodiments are illustrated by way of example, and not by way of limitation, in the figures of the accompanying drawings in which:

FIG. 1 illustrates a device in accordance with an example embodiment;

FIG. 2A illustrates an apparatus for image stabilization in accordance with an example embodiment;

FIG. 2B illustrates an apparatus for image stabilization in accordance with another example embodiment;

FIG. 3 illustrates a simplified configuration of a lens element and a sensor element for performing a pre-determined movement of the lens element and/or the sensor element in accordance with an example embodiment;

FIGS. 4A and 4B illustrate magnitude and phase frequency response plots corresponding to a pre-coded motion blur function, respectively, in accordance with an example embodiment;

FIGS. 5A and 5B illustrate de-blurred image without and with the pre-determined movement of the lens element and/or the sensor element, respectively, in accordance with an example embodiment;

FIGS. 6A and 6B illustrate images captured without and with the pre-determined movement of the lens element and/or the sensor element, respectively, in accordance with an example embodiment;

FIG. 7 is a flowchart depicting an example method for image stabilization in accordance with an example embodiment; and

FIG. 8 is a flowchart depicting an example method for image stabilization in accordance with another example embodiment.

### DETAILED DESCRIPTION

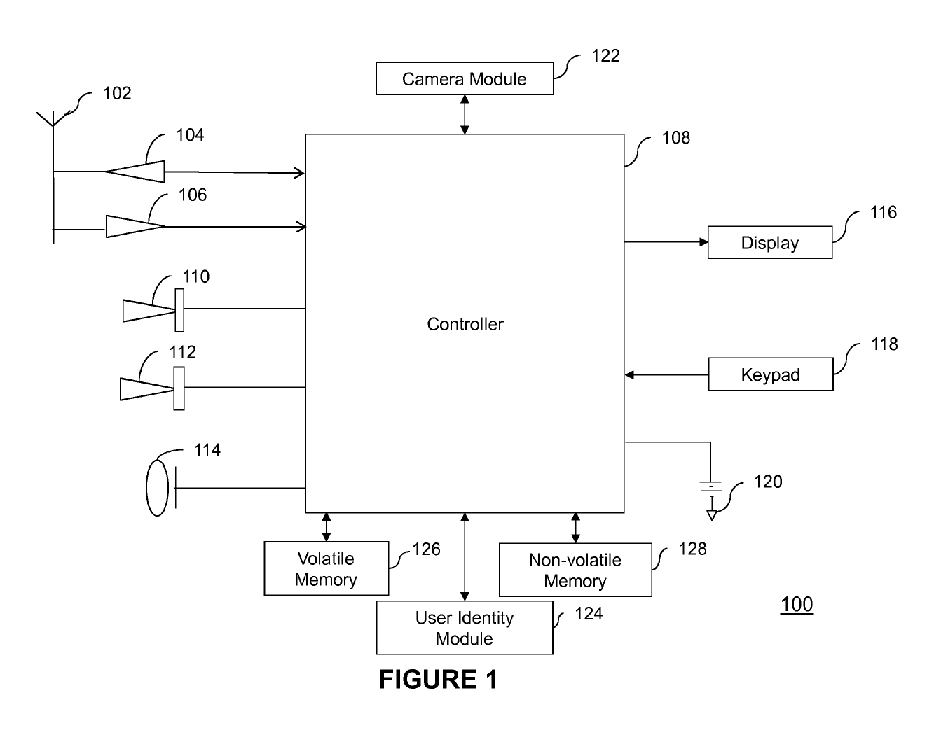

Example embodiments and their potential effects are understood by referring to FIGS. 1 through 8 of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as Bluetooth® networks, Zigbee® networks, Institute of Electric and Electronic Engineers (IEEE) 802.11x networks, and the like; wireline telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively or additionally, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capturing element, such as a camera, video and/or audio module, in communication with the controller 108. The media capturing element may be any means for capturing an image, video and/or audio for storage, display or transmission. In an example embodiment, the media capturing element is a camera module 122 which may include a digital camera capable of forming a digital image file from a captured image. As such, the camera module 122 includes all hardware, such as a lens or other optical component(s), and software for creating a digital image file from a captured image. Alternatively, the camera module 122 may include the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile random access memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

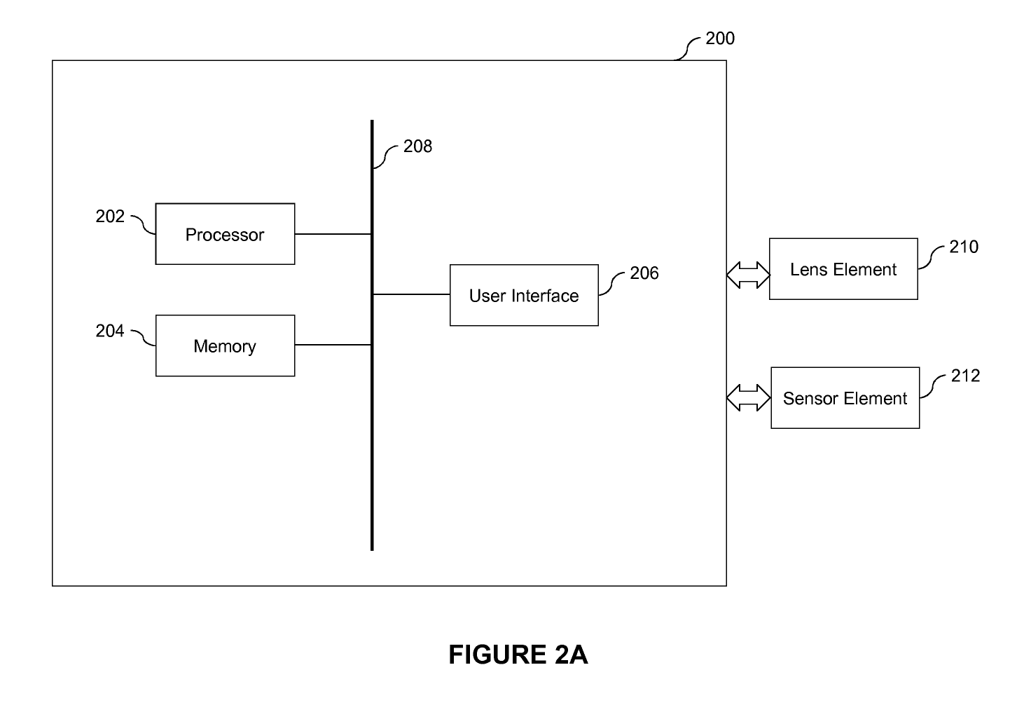

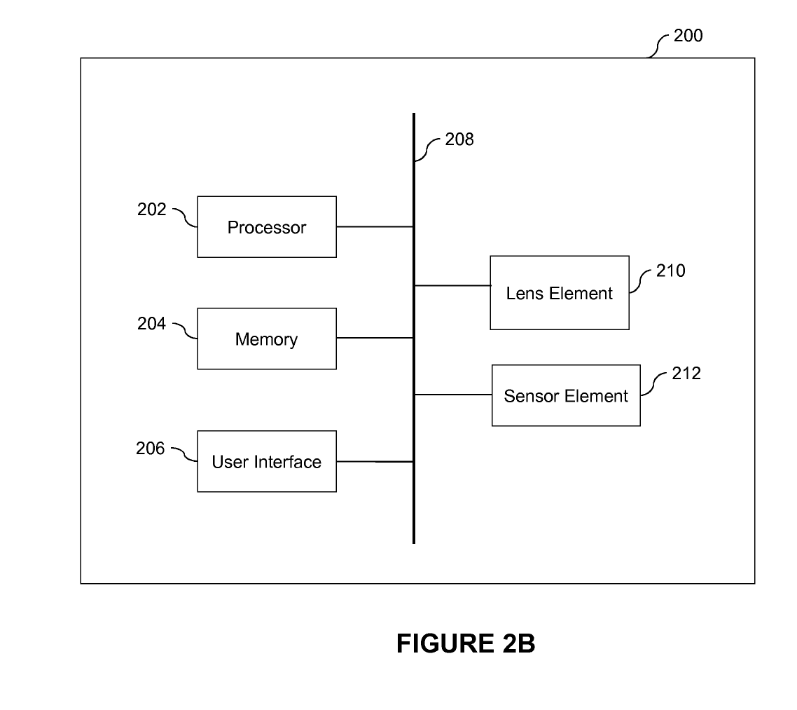

FIG. 2A illustrates an apparatus 200 for image stabilization, in accordance with an example embodiment. The term ‘image stabilization’ as used herein and hereinafter may refer to procedures performed for reducing blurring associated with a motion of image capture apparatus, for example the camera module 122, or motion of object of capture, or both during exposure. The apparatus 200 may be employed, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. Alternatively, embodiments may be employed on a combination of devices including, for example, those listed above. Accordingly, various embodiments may be embodied wholly at a single device, for example, the device 100 or in a combination of devices. Furthermore, it should be noted that the devices or elements described below may not be mandatory and thus some may be omitted in certain embodiments.

The apparatus 200 includes or otherwise is in communication with at least one processor 202 and at least one memory 204. Examples of the at least one memory 204 include, but are not limited to, volatile and/or non-volatile memories. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data comprising media content for processing by the processor 202. Additionally or alternatively, the memory 204 may be configured to store instructions for execution by the processor 202.

An example of the processor 202 may include the controller 108. The processor 202 may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. For example, if the processor 202 is embodied as two or more of an ASIC, FPGA or the like, the processor 202 may be specifically configured hardware for conducting the operations described herein. Alternatively, as another example, if the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface 206 may be in communication with the processor 202. Examples of the user interface 206 include, but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface 206, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the apparatus 200 may include an electronic device. Some examples of the electronic device include communication device, media capturing device with communication capabilities, computing devices, and the like. Some examples of the communication device may include a mobile phone, a personal digital assistant (PDA), and the like. Some examples of computing device may include a laptop, a personal computer, and the like. In an example embodiment, the communication device may include a user interface, for example, the UI 206, having user interface circuitry and user interface software configured to facilitate a user to control at least one function of the communication device through use of a display and further configured to respond to user inputs. In an example embodiment, the communication device may include a display circuitry configured to display at least a portion of the user interface of the communication device. The display and display circuitry may be configured to facilitate the user to control at least one function of the communication device.

In an example embodiment, the communication device may be embodied as to include a transceiver. The transceiver may be any device operating or circuitry operating in accordance with software or otherwise embodied in hardware or a combination of hardware and software. For example, the processor 202 operating under software control, or the processor 202 embodied as an ASIC or FPGA specifically configured to perform the operations described herein, or a combination thereof, thereby configures the apparatus or circuitry to perform the functions of the transceiver. The transceiver may be configured to receive media content. Examples of media content may include audio content, video content, data, and a combination thereof.

These components (202-206) may communicate with each other via a centralized circuit system 208 to perform image stabilization. The centralized circuit system 208 may be various devices configured to, among other things, provide or enable communication between the components (202-206) of the apparatus 200. In certain embodiments, the centralized circuit system 208 may be a central printed circuit board (PCB) such as a motherboard, main board, system board, or logic board. The centralized circuit system 208 may also, or alternatively, include other printed circuit assemblies (PCAs) or communication channel media.

In an example embodiment, the components of the apparatus 200, such as the processor 202, may be in operative communication with a lens element 210 and a sensor element 212. The lens element 210 and the sensor element 212 may be configured to capture digital images and/or multimedia content, such as video content. The apparatus 200 may include other imaging circuitries and/or software in communication with the lens element 210 and the sensor element 212. The lens element 210 and the sensor element 212 and other circuitries, in combination, may be an example of the camera module 122 of the device 100. In an example embodiment, the lens element 210 and the sensor element 212 may configure an image stabilization module, which may be configured to be detachably associated with the apparatus 200 or be included within the apparatus 200. In an example embodiment, the lens element 210 is a floating-lens element and the sensor element 212 is configured to be static during the capturing of the image. The floating lens element may refer to a lens element capable of changing its position as the lens is focused. In an example embodiment, the sensor element 212 is a sensor-shifting element, i.e. capable of movement, and the lens element 210 is configured to be static during the capturing of the image. In an example embodiment, the movement of either of the lens element 210 and the sensor element 212 may be performed to counter a blurring effect introduced in an captured image on account of unsteady camera while capturing the image or on account of the object of capture being in motion or both.

In an example embodiment, the processor 202 is configured to, with the content of the memory 204, and optionally with other components described herein, to cause the apparatus 200 to configure a pre-determined movement of at least one of the lens element 210 and the sensor element 212. The pre-determined movement of the lens element 210 and/or the sensor element 212 may be recorded/stored in a register or a storage location in memory 204. In an example embodiment, a processing means may configure the pre-determined movement of at least one of the lens element 210 and the sensor element 212. An example of the processing means may include the processor 202, which may be an example of the controller 108.

In an embodiment, the pre-determined movement of the at least one of the lens element 210 and the sensor element 212 is performed during capturing of an image. The configured pre-determined movement of at least one the lens element 210 and the sensor element 212 stored in the a register or a storage location in the memory 204 may be executed during the image capture and an image capture may be facilitated using the pre-determined movement of the at least one the lens element 210 and the sensor element 212. In an example embodiment, a processing means may be configured to perform the pre-determined movement of the at least one of the lens element 210 and the sensor element 212 during capturing of the image. An example of the processing means may include the processor 202, which may be an example of the controller 108.

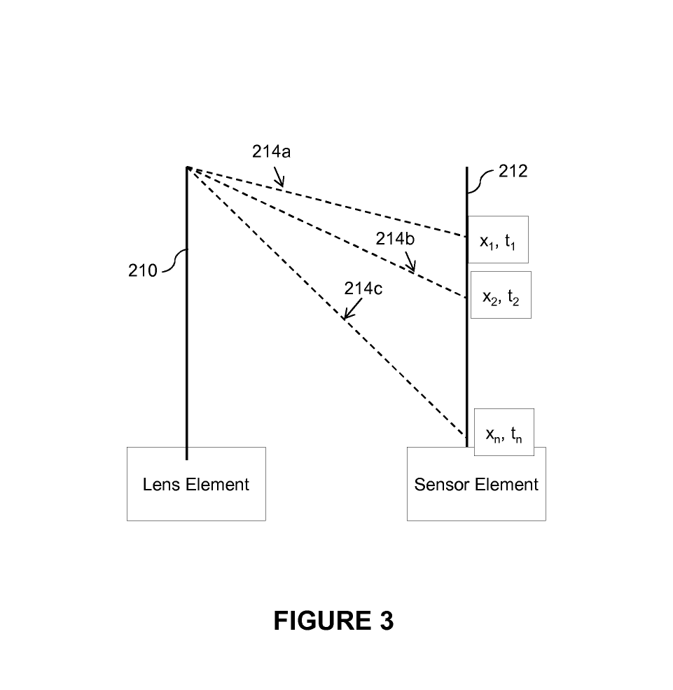

In an embodiment, the pre-determined movement of the lens element 210 and/or the sensor element 212 is configured to direct a light ray from the lens element 210 to pre-determined one or more locations on the sensor element 212. For example, the pre-determined movement of the lens element 210 and/or the sensor element 212 may be configured in a manner to direct the light ray onto the locations like X1, X2 . . . Xn (as shown in FIG. 3) on the sensor element 212. The movement of the lens element and/or the sensor element corresponding to the locations on the sensor element 212 may be pre-determined and stored in the memory 204. During capturing of the image, for example the image of an object in motion, the pre-determined movement of the lens element 210 and/or the sensor element 212 may be performed to direct the light ray (corresponding to the image) on the locations X1, X2 . . . Xn on the sensor element 212.

In another embodiment, the pre-determined movement of the lens element 210 and/or the sensor element 212 is further configured to direct a light ray from the lens element 210 for a pre-determined time duration on each of the pre-determined one or more locations on the sensor element 212. For example, the pre-determined movement of the lens element 210 and/or the sensor element 212 may be configured in a manner to direct the light ray onto the locations like X1, X2 . . . Xn on the sensor element 212 for pre-determined time duration. For example, the light ray could be directed for time duration t1 on location X1, time duration t2 on location X2 . . . time duration to on location Xn. The movement of the lens element and/or the sensor element, the locations on the sensor element 212 and the time durations, such as t1, t2 . . . tn, may be pre-determined and stored in the memory 204. During capturing of the image, for example the image of an object in motion, the pre-determined movement of the lens element 210 and/or the sensor element 212 may be performed to direct the light ray (corresponding to the image) on the locations X1, X2 . . . Xn for pre-determined time durations t1, t2 . . . tn on the sensor element 212.

In yet another embodiment, the pre-determined movement of the lens element 210 and/or the sensor element 212 is configured to vary a focal length associated with the lens element 210 to one or more pre-determined focal lengths. For example, the pre-determined movement of the at least one of lens element 210 and the sensor element 212 may be configured in a manner that a focal length associated with the lens element 210 may be varied to pre-determined focal lengths, for example focal lengths f, 2f and the like. The movement of the lens element 210 and/or the sensor element 212, and the corresponding focal lengths, such as f, 2f, may be pre-determined and stored in the memory 204. During capturing of the image, for example the image of an object in motion, the pre-determined movement of the lens element 210 and/or the sensor element 212 may be performed to direct the light ray (corresponding to the image) while varying the focal lengths to one or more pre-determined focal lengths.

A relative motion between an imaging system, for example the apparatus 200 in conjunction with the lens element 210 and the sensor element 212, and the object being captured may introduce a blurring effect in the observed image. The blurring effect may distort the details of the original image (for example, an image captured without the effects of relative motion). In an example embodiment, the optical path traveled by the light ray (corresponding to the image being captured) may be considered to be optically perfect and convolved with a point spread function (PSF) to produce the observed image. The PSF is a mathematical function that describes the output of an imaging system for an input point source. More specifically, the PSF describes the distortion that a theoretical point source of light experiences on account of traveling along the optical path in the imaging system. The response of the imaging system to the PSF may be referred to as a blur function and may be indicative of motion blur seen in the observed image. More specifically, the blur function may be assumed to represent the motion of the imaging system relative to objects in a scene.

In an example embodiment, the relative motion may be assumed to be constant throughout the image, resulting in globally invariant blur function, which may be obtained through the integration of global motion vectors over a spline curve. In an example embodiment, the relative motion may vary throughout the image resulting in spatially varying blur function, which may be estimated based on optical flow. On determining the blur function, the observed image may be deconvolved to obtain the original undistorted image.

In an embodiment, performing the pre-determined movement of the at least one of the lens element 210 and the sensor element 212 is configured to generate a pre-coded motion blur. More specifically, the pre-coded motion blur may refer to a pre-coded response of the imaging system to the PSF. On account of the pre-determined movement of the lens element 210 and/or the sensor element 212, the pre-coded response to the PSF may be configured such that a corresponding frequency response is relatively flat (for example, with fewer zero crossings in the frequency response). As a result of the flatter frequency response (fewer zero crossings in the frequency response), when the PSF is convolved, i.e. multiplied with imaging signal (corresponding to the image being captured), the resulting observed image retains a number of details corresponding to the original image. The pre-determined movement is performed so that the motion blur itself retains decodable details of the moving object thereby simplifying deblurring of the image.

In an example embodiment, a deconvolution of an observed image corresponding to the captured image is performed based on the pre-coded motion blur for attaining substantially motion deblurred observed image. In an example embodiment, motion deblurring can be cast as the deconvolution of an image that has been convolved with either a global motion PSF or a spatially variant PSF. In an example embodiment, blind deconvolution methods may be utilized to estimate the PSF from the blurred image and use the PSF to deconvolve the image. These methods include well-known algorithms such as Richardson Lucy and Wiener deconvolution.

The Richardson-Lucy algorithm is an iterative deconvolution algorithm derived from Bayes theorem that minimizes the following estimation error:

$$arg {min}_{I} n ( \vert \vert {I}_{b} - I ⊗ K {\vert \vert}^{2} )$$

where I is the deblurred image, K is the blur function, Ib is the observed blur image, and n(.) is the noise distribution. A solution can be obtained using the iterative update algorithm defined as follows:

$${I}^{t + 1} = {I}^{t} \times K * \frac{{I}_{b}}{{I}^{t} ⊗ K}$$

where * is the correlation operation. A blind deconvolution algorithm using the Richardson-Lucy algorithm iteratively optimizes I and K in alternation.

For spatially invariant blur functions, the following optimization equation may be utilized:

$$arg {min}_{I , K} {Σ}_{i}^{N} ( \vert \vert {I}_{bi} - I ⊗ {K}_{i} {\vert \vert}^{2} ) + {λ}_{K} {Σ}_{i}^{N} \vert \vert {K}_{i} - {K}_{oi} {\vert \vert}^{2}$$

where I and K are sharp images, and blur functions Ib and Ko are blur functions in observed blur images and estimated blur functions from optical flow respectively. For spatially varying blur functions, the following equation may be used:

$$arg {min}_{I , K} {Σ}_{i}^{N} \vert \vert {I}_{bi} - {Σ}_{l}^{P} {a}_{il} ( I ⊗ {K}_{i} ) {\vert \vert}^{2} + {λ}_{K} {Σ}_{i}^{N} {Σ}_{l}^{P} \vert \vert {a}_{il} {k}_{il} - {a}_{oil} {k}_{il} {\vert \vert}^{2}$$

In an example embodiment, a least least-square estimation may be utilized to obtain the deblurred image as follows:

A=X−1B

Where B is the observed image, A is the deblurred image and X is the blur function. A pseudo-inverse X-1 of the estimated blur function X may be computed in the least squares sense and may be used to obtain the deblurred image. In an example embodiment, a processing means may be configured to perform motion deblurring by performing deconvolution of the observed image based on the pre-coded motion blur. An example of the processing means may include the processor 202, which may be an example of the controller 108.

In an embodiment, an image of an object (in motion or otherwise) is captured using a first image capture mode and a second image capture mode, and where the pre-determined movement of the at least one of a lens element 210 and a sensor element 212 is performed during capture of the image using each of the first capture mode and the second capture mode. In an embodiment, the first image capture mode is flash mode of image capture and the second image capture mode is a non-flash mode of image capture. In an example embodiment, a pre-coded motion blur may be generated for image captured using each of the first capture mode and the second capture mode and resulting blurred images be obtained for each of the capture modes. In an example embodiment, the pre-determined movement of the lens element 210 and/or the sensor element may be configured differently for flash and non-flash image capture modes to generate different pre-coded motion blurs. The motion deblurred image may be obtained by combining the blurred images obtained using the first capture mode and the second capture mode. This may especially be useful for achieving better colours in low-light conditions for image capture.

In an example embodiment, images blurred in orthogonal directions (for example, a horizontally blurred image and a vertically blurred image) may be utilized to obtain a single motion deblurred image. In an example embodiment, a single deblurred image may be generated from a blurry image sequence. In another example embodiment, a single deblurred image may be generated from a noisy image and a blurred image. In an example embodiment, an additional imaging sensor may be utilized to capture a low-resolution imagery and then combined with blurred image obtained from a high-resolution imagery to obtain the motion deblurred image.

In an example embodiment, multiple pre-determined movements of the lens element 210 and/or the sensor element 212 (i.e. multiple pre-coded motion blur functions) may be configured, and stored in the register or the storage location in memory 204. Based on a motion associated with the object, a pre-determined movement of the lens element 210 and/or the sensor element 212 may be chosen, either dynamically by the processor 202 or manually by a user, from among the stored multiple pre-determined movements of the lens element 210 and/or the sensor element 212 and performed during the capturing of the image for achieving better deblurring of motion in the captured image.

In an example embodiment, a stereo camera may additionally be utilized during capturing of an image of an object in motion. The stereo camera may be configured to simultaneously record the motion of the object while the pre-determined movement of the lens element 210 and/or the sensor element 212 is being performed during the image capture. An analysis of the motion, such as determination of motion vectors and the like, associated with the object may be performed using the recorded motion by the stereo camera. Based on the analysis, a motion of the object may be determined and utilized for achieving better deblurring of motion in the captured image.

It should be noted that though the lens element 210 and the sensor element 212 are depicted to be operatively associated with the apparatus 200 in FIG. 2A, the lens element 210 and the sensor element 212 may be configured to be included in the apparatus 200. Such an apparatus for image stabilization is shown in FIG. 2B. The apparatus 200 of FIG. 2B is depicted to include the lens element 210 and the sensor element 212 in addition to the processor 202, memory 204, the user interface 206 and the centralized circuit system 208. The various components of the apparatus 200 of FIG. 2B, such as the processor 202, the memory 204, the user interface 206, the centralized circuit system 208, the lens element 210 and the sensor element 212 perform similar functions as explained in FIG. 2A and are not explained herein. More specifically, the configuration of the pre-determined movement of the lens element 210 and/or the sensor element 212, the performing of the pre-determined movement during capturing of the image and subsequent motion deblurring of the observed image by performing deconvolution of the observed image based on the pre-coded motion blur may be performed in similar manner as explained in FIG. 2A.

FIG. 3 illustrates a simplified configuration of the lens element 210 and the sensor element 212 for performing the pre-determined movement of the lens element 210 and/or the sensor element 212 in accordance with an example embodiment. Further, the configuration as depicted in FIG. 3 may be included in the apparatus 200 as shown in FIG. 2B, or, may be operatively associated with the apparatus 200 as shown in FIG. 2A. Further, as explained in FIG. 2A, the pre-determined movement of the lens element 210 and/or the sensor element 212 may be configured and the configured pre-determined movement to be performed while capturing an image may be stored in a register or a storage location in memory 204.

As shown in FIG. 3, the pre-determined movement of the lens element 210 and/or the sensor element 212 may be configured to direct a light ray from the lens element 210 to pre-determined one or more locations on the sensor element 212. For example, the light ray may be directed along path 214a to a location X1 on the sensor element 212. Similarly, the light rays may be directed along paths 214b and 214n to locations X2 and Xn on the sensor element 212, respectively. Further, the pre-determined movement of the lens element 210 and/or the sensor element 212 is configured to direct the light rays from the lens element 210 along the paths 214a, 214b and 214n for a pre-determined time duration on each of the pre-determined one or more locations on the sensor element 212. For example, the light ray could be directed for time duration t1 on location X1, time duration t2 on location X2 and time duration to on location Xn. The movement of the lens element 210 or the sensor element 212, the locations on the sensor element 212 and the time durations, such as t1, t2 . . . tn, may be pre-determined and stored in the memory 204. During capturing of the image, for example the image of an object in motion, the pre-determined movement of the lens element 210 and/or the sensor element 212 may be performed to direct the light ray (corresponding to the image) on the locations X1, X2 . . . Xn for pre-determined time durations t1, t2 . . . tn on the sensor element 212.

In an example embodiment, the pre-determined movement of the lens element 210 and/or the sensor element 212 is configured to vary a focal length associated with the lens element 210 to one or more pre-determined focal lengths. For example, a focal length associated with the lens element 210 may be varied to pre-determined focal lengths such as focal lengths f1, 2f (not shown in FIG. 3) and the like.

In an example embodiment, an output of the pre-determined movement of the lens element 210 and/or the sensor element 212 may be perceived as a filter with finite impulse response and capable of preserving low frequency details. Such a filter may be represented by:

Y=[x1t1+x2t2+ . . . . xntn]

Where Y represents the filter output and x1, x2 . . . xn represent locations on the sensor element 212 and t1, t2 . . . to represent the time duration for which the light ray is directed at a particular sensor location. In another example embodiment, a filter [1 2 1] may be generated for a still point source, implying that the pre-determined movement of the lens element 210 and/or the sensor element 212 directs the light ray for t duration of the capture at location X, for 2t duration of the capture at X+1, and for t duration of the capture at X+2.

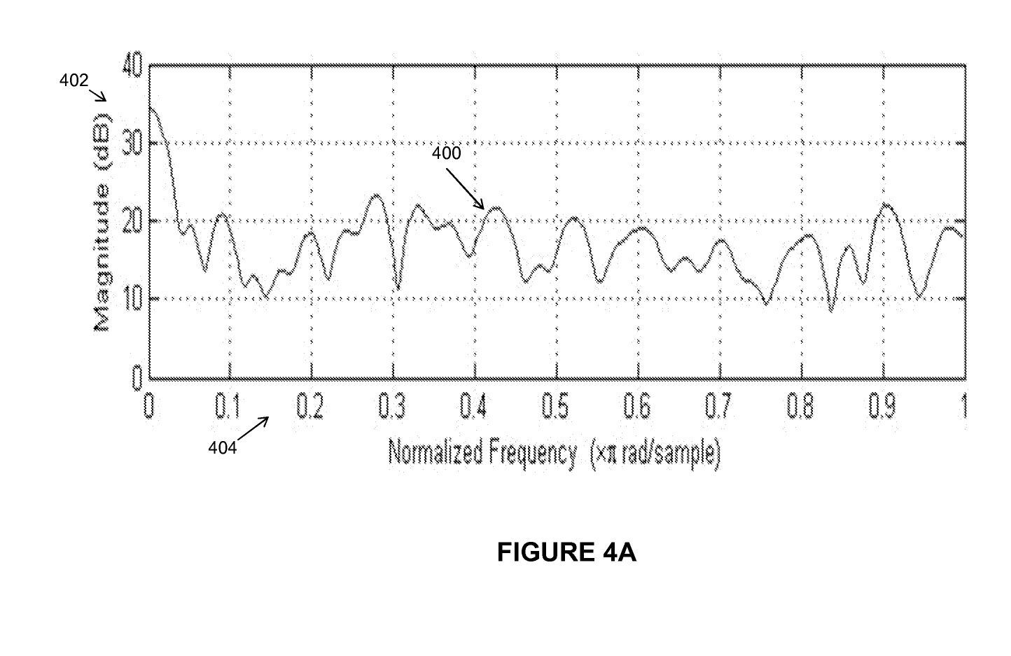

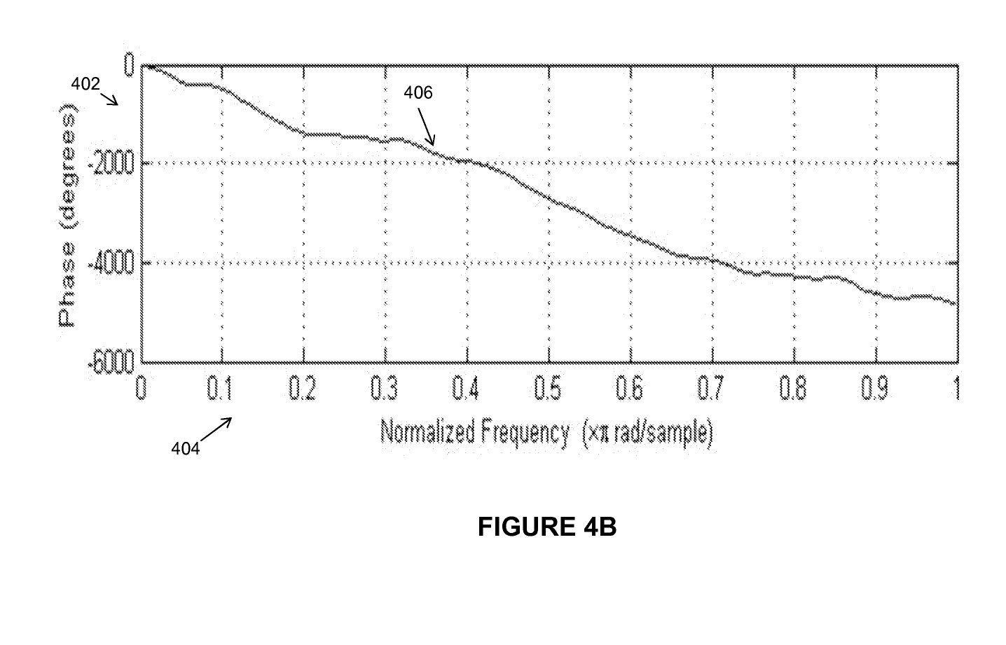

As explained in FIG. 2A, the response of the filter (i.e, the arrangement of the lens element 210 and the sensor element 212) to the PSF may be referred to as the blur function. The blur function may be designed through the pre-determined movement of the lens element 210 and/or the sensor element 212 such that the motion blur is pre-coded and retains decodable details of the moving object thereby simplifying deblurring of the image. A response to an exemplary blur function is explained in FIGS. 4A and 4B.

FIGS. 4A and 4B illustrate magnitude and phase frequency response plots corresponding to a pre-coded motion blur function, respectively, in accordance with an example embodiment. The pre-determined movement of the lens element 210 and/or the sensor element 212 may be designed to generate a pre-coded motion blur, i.e. a pre-designed blur function.

In an example embodiment, for a object motion of 52 pixels in the capture duration, in absence of the pre-determined movement of the lens element 210 and/or the sensor element 212, following blur function may be generated:

‘1111111111111111111111111111111111111111111111111111’

The pre-determined movement of the lens element 210 and/or the sensor element may be configured in such a manner that a following sequence of locations on the sensor element 212 may be achieved: [0 −1 0 −1 3 2 2 1 1 0 5 4 5 4 8 7 7 6 8 7 7 6 6 5 5 4 5 4 4 3 3 2 3 2 3 2 2 1 1 0 2 1 3 2 2 1 3 2 2 1 1 0], where 0 corresponds to the initial position on the sensor element 212, −1 represents a movement of one pixel in the opposite direction of the motion of the object and so on and so forth. A time duration for which the lens element 210 directs the light ray corresponding to the object being captured for each of these sensor locations may be ˜2 ms time duration. The blur function of the moving object as observed on the sensor element 212 corresponding to such a configuration may be generated as follows:

‘2020000222000002020000220022220222020222002002200222’

A magnitude and phase response plots corresponding to the above blur function is depicted in FIGS. 4A and 4B.

FIG. 4A depicts a plot 400 depicting variations in magnitude (plotted on X-axis 402) with change in normalized frequency (plotted on Y-axis 404). The magnitude is measured in decibels (dB) and the normalized frequency is measured in xm radians/sample. FIG. 4B depicts a plot 406 depicting variations in phase (plotted on X-axis 402) with change in normalized frequency (plotted on Y-axis 404). The phase is measured in degrees and the normalized frequency is measured in xm radians/sample. As can be seen from the plots, the frequency response plots 400 and 406 are relatively flat and linear, respectively, with no zero crossings in plot 400 implying that frequency details corresponding to the motion blur are retained. When the frequency response plots 400, 406 are convolved with the imaging signal, on account of no zero crossings, very few details are lost and the resulting deconvolved image is deblurred better, i.e. retains a number of details corresponding to the original image.

As explained in FIG. 2A, multiple pre-coded motion blur functions, such as the blur function corresponding to plots 400 and 406, may be configured, and stored in the register or the storage location in memory 204. Based on a motion associated with the object, a pre-determined movement of the lens element 210 and/or the sensor element 212 may be chosen, either dynamically by the processor 202 or manually by a user, from among the stored multiple pre-coded motion blur functions of the lens element 210 and/or the sensor element 212 and performed during the capturing of the image for achieving better deblurring of motion in the captured image.

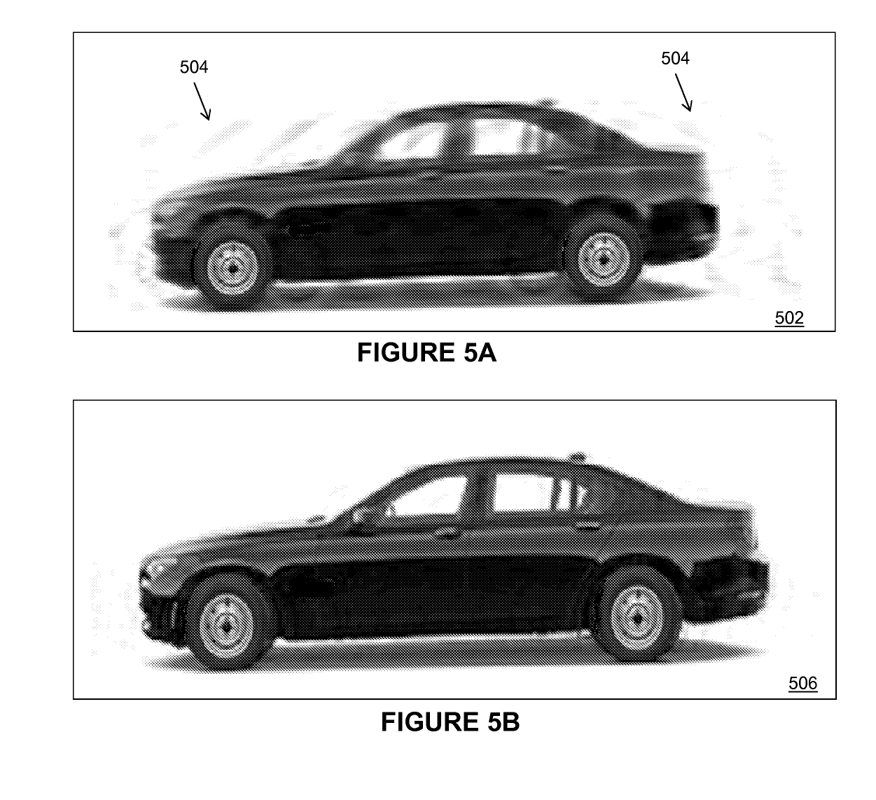

FIGS. 5A and 5B depict deblurred images without and with the pre-determined movement of the lens element 210 and/or the sensor element 212, respectively, in accordance with an example embodiment. In an example embodiment, in absence of the pre-determined movement of the lens element 210 and/or the sensor element 212, for an object motion of 52 pixels in the capture duration, following blur function may be generated:

‘1111111111111111111111111111111111111111111111111111’

A blurred image may result on account of convolution of the captured image of the object (depicted to be a car in motion) with the above blur function. A subsequent deblurring of the image using deconvolution techniques explained in FIG. 2A may provide the deblurred image 502 of FIG. 5A.

In an example embodiment, the pre-determined movement of the lens element 210 and/or the sensor element 212 may generate the following blur function:

‘2020000222000002020000220022220222020222002002200222’

which may result in a blurred image on account of convolution with the captured image of the object (depicted to be a car in motion). A subsequent deblurring of the image using deconvolution techniques explained in FIG. 2A may provide the deblurred image 506 of FIG. 5B.

As can be seen from FIGS. 5A and 5B, the deblurred image 502 includes considerably higher ringing artifacts, such as ringing artifacts 504, as compared to the deblurred image 504. In an example embodiment, ringing artifacts may be artifacts that appear as spurious signals near sharp transitions in a signal. As can be seen from FIGS. 5A and 5B, the pre-coded motion blur generated by the pre-determined movement of the lens element 210 and/or the sensor element 212 reduces ringing artifacts and results in better motion deblurring of images.

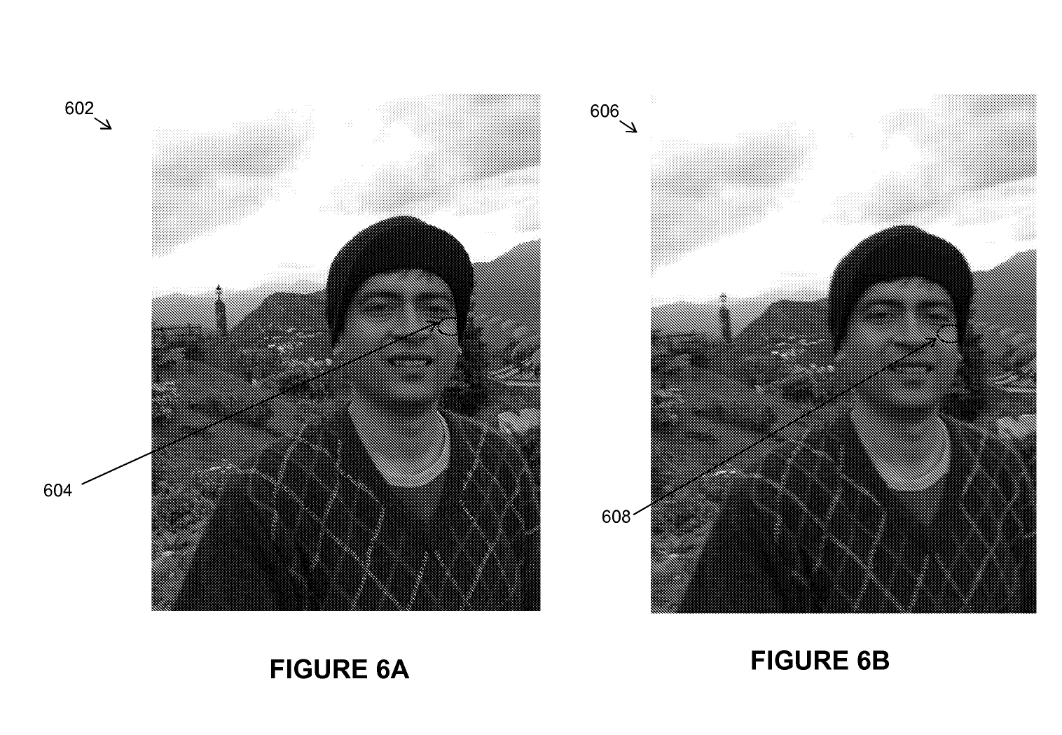

FIGS. 6A and 6B illustrate images captured without and with the pre-determined movement of the lens element 210 and/or the sensor element 212, respectively, in accordance with an example embodiment. The image 602 in FIG. 6A corresponds to an image captured without the movement of the lens element 210 and/or the sensor element 212. As can be seen from the FIG. 6A, the facial portion 604 includes a dark spot (below a left eye portion).

The pre-determined movement of the lens element 210 and/or the sensor element 212 may be configured in such a manner that a focal length may be varied, for example f, 2f and the like, and such a movement may aid in diffusing, i.e. spreading the light rays without affecting the sharpness and the contrast of the image. The diffusion may help soften and in some cases completely eliminate small skin defects, such as the dark spot as depicted in corresponding facial portions 608 of image 604 in FIG. 6B, which corresponds to the image captured with the pre-determined movement of the lens element 210 and/or the sensor element 212.

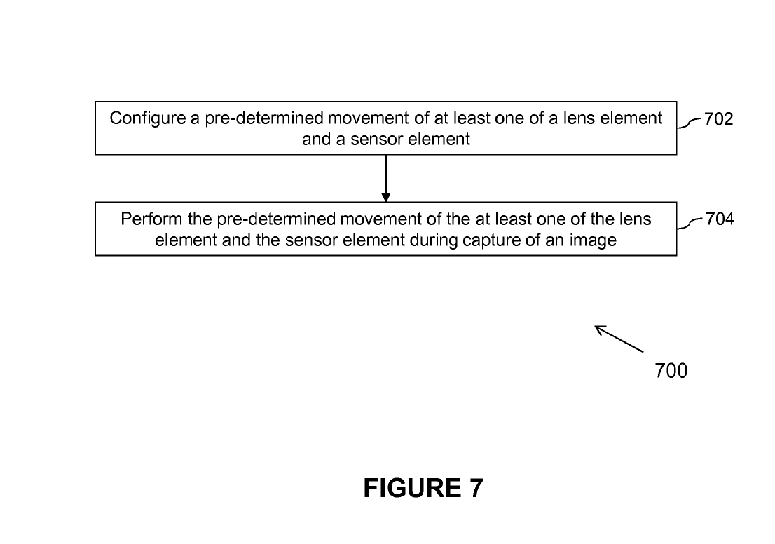

The movement of the lens element 210 or the sensor element 212, and the corresponding focal lengths, such as f, 2f and the like may be pre-determined and stored in the memory 204. During capturing of the image, for example the facial portion, the pre-determined movement of one of the lens element 210 and the sensor element 212 may be performed to direct the light ray (corresponding to the image) while varying the focal lengths to one or more pre-determined focal lengths. By varying a focal length while capturing an image, such as image of a face of a person, a softening of facial features, such as wrinkles, creases and dark spots, may be achieved as can be seen in FIG. 6B. The pre-determined movement of the lens element 210 and/or the sensor element 212 may thus preclude the need to include a diffusion filter for softening images. A method for image stabilization is explained in FIG. 7.

FIG. 7 is a flowchart depicting an example method 700 for image stabilization, in accordance with an example embodiment. The method depicted in the flow chart may be executed by, for example, the apparatus 200 of FIG. 2A or FIG. 2B. In an embodiment, the image stabilization may be performed to counter a blurring effect introduced in an captured image on account of unsteady image capturing apparatus while capturing the image or on account of the object of capture being in motion or both.

At block 702, a pre-determined movement of at least one of the lens element and the sensor element is configured. The lens element and the sensor element may be similar to the lens element 210 and the sensor element 212 explained in FIG. 2A, respectively. The lens element and the sensor element may be configured to capture digital images and/or multimedia content, such as video content. The lens element and the sensor element and other circuitries, in combination, may be an example of the camera module 122 of the device 100. In an example embodiment, the lens element and the sensor element may configure an image stabilization module, which may be configured to be detachably associated with the apparatus 200 or be included within the apparatus 200. In an example embodiment, the lens element is a floating-lens element and the sensor element is configured to be static during the capturing of the image. The floating lens element may refer to a lens element capable of changing its position as the lens is focused. In an example embodiment, the sensor element is a sensor-shifting element, i.e. capable of movement, and the lens element is configured to be static during the capturing of the image. In an example embodiment, the movement of either of the lens element and the sensor element may be performed to counter a blurring effect introduced in an captured image on account of unsteady camera while capturing the image or on account of the object of capture being in motion or both. The configured pre-determined movement of the lens element and/or the sensor element to be performed while capturing an image may be stored in a register or a storage location in memory, such as memory 204.

At block 704, the pre-determined movement of the at least one of the lens element and the sensor element is performed during capturing of an image. The pre-determined movement of the lens element and/or the sensor element stored in the register or a storage location in the memory may be executed during the image capture and an image capture may be facilitated using the pre-determined movement of the lens element and/or the sensor element.

In an example embodiment, the pre-determined movement of the lens element and/or the sensor element is configured to direct a light ray from the lens element to pre-determined one or more locations on the sensor element. For example, the pre-determined movement of the lens element and/or the sensor element may be configured in a manner to direct the light ray onto the locations like X1, X2 . . . Xn (as shown in FIG. 3) on the sensor element. In another embodiment, the pre-determined movement of the lens element and/or the sensor element is configured to direct a light ray from the lens element for a pre-determined time duration on each of the pre-determined one or more locations on the sensor element. For example, the light ray could be directed for time duration t1 on location X1, time duration t2 on location X2 . . . time duration to on location Xn.

In an embodiment, the pre-determined movement of the lens element and/or the sensor element is configured to vary a focal length associated with the lens element to one or more pre-determined focal lengths. For example, the pre-determined movement of the lens element and/or the sensor element may be configured in a manner that a focal length associated with the lens element may be varied to pre-determined focal lengths, for example focal lengths f, 2f and the like. The movement of the lens element and/or the sensor element, and the corresponding focal lengths, such as f, 2f, may be pre-determined and stored in the memory. During capturing of the image, for example the image of an object in motion, the pre-determined movement of one of the lens element and the sensor element may be performed to direct the light ray (corresponding to the image) while varying the focal lengths to one or more pre-determined focal lengths.

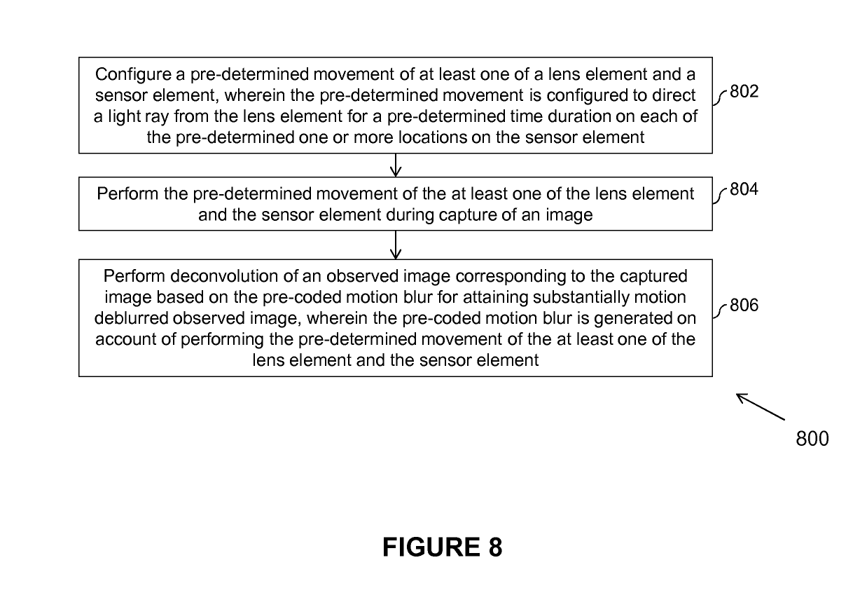

In an embodiment, the pre-determined movement of the lens element and/or the sensor element is configured to generate a pre-coded motion blur. As explained in FIG. 2A, the pre-coded motion blur may refer to a pre-coded response of an imaging system to the PSF. On account of the pre-determined movement of the lens element and/or the sensor element, the pre-coded response to the PSF may be configured such that a corresponding frequency response is relatively flat (for example, frequency response with few or no zero crossings in the frequency response as depicted in FIG. 4A). As a result of the flatter frequency response, when the PSF is convolved, i.e. multiplied with imaging signal (corresponding to the image being captured), the resulting observed image retains a number of details corresponding to the original image. The pre-determined movement is performed so that the motion blur itself retains decodable details of the moving object thereby simplifying deblurring of the image. In an example embodiment, the substantially motion deblurred image is attained by performing deconvolution of the observed image obtained based on the pre-coded motion blur as explained in FIG. 2A. Another method for image stabilization is explained in detail with reference to FIG. 8.

FIG. 8 is a flowchart depicting an example method 800 for Image stabilization, in accordance with another example embodiment. The method 800 depicted in flow chart may be executed by, for example, the apparatus 200 of FIGS. 2A and/or 2B. Operations of the flowchart, and combinations of operation in the flowchart, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the method 800 are described with help of apparatus 200. However, the operations of the method can be described and/or practiced by using any other apparatus.

At block 802, a pre-determined movement of at least one of a lens element, such as the lens element 210, and a sensor element, such as the sensor element 212 is configured. The pre-determined movement is configured to direct a light ray from the lens element for a pre-determined time duration on each of the pre-determined one or more locations on the sensor element. For example, the light ray could be directed for time duration t1 on location X1, time duration t2 on location X2 . . . time duration to on location Xn.

The movement of the at least one of the lens element or the sensor element, the locations on the sensor element and the time durations, such as t1, t2 . . . tn, may be pre-determined and stored in the memory. During capturing of the image, for example the image of an object in motion, the pre-determined movement of one of the lens element and the sensor element may be performed to direct the light ray (corresponding to the image) on the locations X1, X2 . . . Xn for pre-determined time durations t1, t2 . . . tn on the sensor element.

At block 804, the pre-determined movement of the at least one of the lens element and the sensor element is performed during capturing of an image. The pre-determined movement of the lens element and/or the sensor element stored in the register or a storage location in the memory may be executed during the image capture and an image capture may be facilitated using the pre-determined movement of the lens element and/or the sensor element.

In an embodiment, the pre-determined movement of the lens element and/or the sensor element is configured to generate a pre-coded motion blur. The pre-determined movement is performed so that the motion blur itself retains decodable details of the moving object thereby simplifying deblurring of the image. At block 806, a deconvolution of an observed image corresponding to the captured image is performed based on the pre-coded motion blur for attaining substantially motion deblurred observed image.

In an example embodiment, motion deblurring can be cast as the deconvolution of an image that has been convolved with either a global motion PSF or a spatially variant PSF. In an example embodiment, blind deconvolution methods may be utilized to estimate the PSF from the blurred image and use the PSF to deconvolve the image. These methods include well-known algorithms such as Richardson Lucy and Wiener deconvolution.

As explained in FIG. 2A, for spatially invariant blur functions, the following optimization equation, based on Richardson-Lucy deconvolution algorithm, may be utilized:

$$arg {min}_{I , K} {Σ}_{i}^{N} ( \vert \vert {I}_{bi} - I ⊗ {K}_{i} {\vert \vert}^{2} ) + {λ}_{K} {Σ}_{i}^{N} \vert \vert {K}_{i} - {K}_{oi} {\vert \vert}^{2}$$

where I and K are sharp images, and blur functions Ib and Ko are blur functions in observed blur images and estimated blur functions from optical flow respectively. For spatially varying blur functions, the following equation may be used:

$$arg {min}_{I , K} {Σ}_{i}^{N} \vert \vert {I}_{bi} - {Σ}_{l}^{P} {a}_{il} ( I ⊗ {K}_{i} ) {\vert \vert}^{2} + {λ}_{K} {Σ}_{i}^{N} {Σ}_{l}^{P} \vert \vert {a}_{il} {k}_{il} - {a}_{oil} {k}_{il} {\vert \vert}^{2}$$

In an example embodiment, a least least-square estimation may be utilized to obtain the deblurred image as follows:

A=X−1B

Where B is the observed image, A is the deblurred image and X is the blur function. A pseudo-inverse X-1 of the estimated blur function X may be computed in the least squares sense and may be used to obtain the deblurred image.

In an embodiment, an image of an object (in motion or otherwise) is captured using a first image capture mode and a second image capture mode, where the pre-determined movement of the lens element and/or the sensor element is performed during capture of the image using each of the first capture mode and the second capture mode. In an embodiment, the first image capture mode is flash mode of image capture and the second image capture mode is a non-flash mode of image capture. In an example embodiment, a pre-coded motion blur may be generated for image captured using each of the first capture mode and the second capture mode and resulting blurred images be obtained for each of the capture modes. In an example embodiment, the pre-determined movement of the lens element and/or the sensor element may be configured differently for flash and non-flash image capture modes to generate different pre-coded motion blurs. The motion deblurred image may be obtained by combining the blurred images obtained using the first capture mode and the second capture mode. This may especially be useful for achieving better colours in low-light conditions for image capture.

In an example embodiment, a processing means may be configured to perform some or all of: configuring a pre-determined movement of at least one of a lens element and a sensor element, wherein the pre-determined movement is configured to direct a light ray from the lens element for a pre-determined time duration on each of the pre-determined one or more locations on the sensor element; performing the pre-determined movement of the at least one of the lens element and the sensor element during capturing of an image; and performing deconvolution of an observed image corresponding to the captured image based on the pre-coded motion blur for attaining substantially motion deblurred observed image, wherein the pre-coded motion blur is generated on account of performing the pre-determined movement of the at least one of the lens element and the sensor element. An example of the processing means may include the processor 202, which may be an example of the controller 108.

To facilitate discussion of the method 800 of FIG. 8, certain operations are described herein as constituting distinct steps performed in a certain order. Such implementations are exemplary and non-limiting. Certain operation may be grouped together and performed in a single operation, and certain operations can be performed in an order that differs from the order employed in the examples set forth herein. Moreover, certain operations of the method 800 are performed in an automated fashion. These operations involve substantially no interaction with the user. Other operations of the method 800 may be performed by in a manual fashion or semi-automatic fashion. These operations involve interaction with the user via one or more user interface presentations.

Without in any way limiting the scope, interpretation, or application of the claims appearing below, a technical effect of one or more of the example embodiments disclosed herein is to perform stabilization of images. As explained in FIGS. 2A-8, image stabilization corresponds to countering a blurring effect in images captured with the object in motion or in images captured with an unsteady image capture system. Such stabilization of images may be utilized for deblurring a blurring effect in images captured with the object in motion or in images captured with an unsteady image capture system. The pre-determined movement of the lens element and/or the sensor element is designed to generate a pre-coded motion blur, i.e. a pre-designed blur function. A frequency response corresponding to such a blur function is relatively flat with few or no zero crossings implying that frequency details corresponding to the motion blur are retained. When such a blur function is convolved with the imaging signal, on account of few zero crossings, very few details are lost and the resulting deconvolved image is deblurred better, i.e. retains a number of details corresponding to the original image. As explained in FIG. 2A, several such pre-coded motion blur functions may be stored and utilized selectively based on the motion of the object being captured. The pre-determined movement of the lens element and/or the sensor element may also be utilized for diffusion applications and softening captured images without the need to include specialized diffusion filters as explained in FIGS. 6A and 6B.

The pre-determined movement of the lens element and/or the sensor element may be especially useful in high dynamic range (HDR) applications which primarily deals with compensating loss of detail in bright or dark areas of a picture, depending on whether the image capture apparatus had a low or high exposure setting. In such applications, by spreading out pixels over a large sensor area, using pre-coded blur function (corresponding to a designed filter having an all pass response with linear phase), saturation of the pixels may be avoided. The image/video can then be deconvolved to achieve a high quality image.

In some embodiments, an image viewer may only be interested in viewing a moving object of interest in un-blurred form and may be uninterested in the remaining portions of the image. In an example embodiment, the motion of the object of interest may be analyzed, for example using stereo cameras and based upon the motion vectors, the pre-determined movement of the lens element and/or the sensor element may be programmed such that the light rays emitted from moving object are directed at a single point on the sensor element. Without the need to perform a deblurring procedure, such programming of the lens element and/or sensor element movement may result in the object appearing still, with the rest of the image in blurred form. In some embodiments, an analysis of the motion recorded (for example, simultaneously during image capture) by the stereo camera may be used to determine a motion associated with the object in the image and the determined motion may be utilized for better deblurring of the motion of the object in the image.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present disclosure as defined in the appended claims.

1-43. (canceled)

44. A method comprising:
configuring a pre-determined movement of at least one of a lens element and a sensor element; and
performing the pre-determined movement of the at least one of the lens element and the sensor element during capturing of an image.

45. The method as claimed in claim 44, wherein the pre-determined movement of the at least one of the lens element and the sensor element is configured to direct a light ray from the lens element to pre-determined one or more locations on the sensor element.

46. The method as claimed in claim 45, wherein the pre-determined movement of the at least one of the lens element and the sensor element is further configured to direct a light ray from the lens element for a pre-determined time duration on each of the pre-determined one or more locations on the sensor element.

47. The method as claimed in claim 44, wherein the pre-determined movement of the at least one of the lens element and the sensor element is configured to vary a focal length associated with the lens element to one or more pre-determined focal lengths.

48. The method as claimed in claim 44, wherein performing the pre-determined movement of the at least one of the lens element and the sensor element is configured to generate a pre-coded motion blur in an observed image corresponding to the captured image.

49. The method as claimed in claim 48, further comprising performing deconvolution of the observed image based on the pre-coded motion blur for attaining substantially motion deblurred observed image.

50. The method as claimed in claim 44, wherein the image is captured using a first image capture mode and a second image capture mode, and wherein the pre-determined movement of the at least one of the lens element and the sensor element is performed during capture of the image using each of the first capture mode and the second capture mode.

51. An apparatus comprising:
at least one processor; and
at least one memory comprising computer program code, the at least one memory and the computer program code configured to, with the at least one processor, cause the apparatus to at least perform:
configure a pre-determined movement of at least one of a lens element and a sensor element; and
perform the pre-determined movement of the at least one of the lens element and the sensor element during capturing of an image.

52. The apparatus as claimed in claim 51, wherein the pre-determined movement of the at least one of the lens element and the sensor element is configured to direct a light ray from the lens element to pre-determined one or more locations on the sensor element.

53. The apparatus as claimed in claim 52, wherein the pre-determined movement of the at least one of the lens element and the sensor element is further configured to direct a light ray from the lens element for a pre-determined time duration on each of the pre-determined one or more locations on the sensor element.

54. The apparatus as claimed in claim 51, wherein the pre-determined movement of the at least one of the lens element and the sensor element is configured to vary a focal length associated with the lens element to one or more pre-determined focal lengths.

55. The apparatus as claimed in claim 51, wherein the lens element comprises a floating-lens element and the sensor element is configured to be static during the capturing of the image.

56. The apparatus as claimed in claim 51, wherein the sensor element comprises a sensor-shifting element and the lens element is configured to be static during the capturing of the image.

57. The apparatus as claimed in claim 51, wherein performing the pre-determined movement of the at least one of the lens element and the sensor element is configured to generate a pre-coded motion blur in an observed image corresponding to the captured image.

58. The apparatus as claimed in claim 57, wherein the apparatus is further caused, at least in part, to:
perform deconvolution of the observed image based on the pre-coded motion blur for attaining substantially motion deblurred observed image.

59. The apparatus as claimed in claim 51, wherein the image is captured using a first image capture mode and a second image capture mode, and, wherein the pre-determined movement of the at least one of the lens element and the sensor element is performed during capture of the image using each of the first capture mode and the second capture mode.

60. A computer program product comprising at least one computer-readable storage medium, the computer-readable storage medium comprising a set of instructions, which, when executed by one or more processors, cause an apparatus at least to perform:
configure a pre-determined movement of at least one of a lens element and a sensor element; and
perform the pre-determined movement of the at least one of the lens element and the sensor element during capturing of an image.

61. The computer program product as claimed in claim 60, wherein the pre-determined movement of the at least one of the lens element and the sensor element is configured to direct a light ray from the lens element to pre-determined one or more locations on the sensor element.

62. The computer program product as claimed in claim 61, wherein the pre-determined movement of the at least one of the lens element and the sensor element is further configured to direct a light ray from the lens element for a pre-determined time duration on each of the pre-determined one or more locations on the sensor element.

63. The computer program product as claimed in claim 60, wherein the pre-determined movement of the at least one of the lens element and the sensor element is configured to vary a focal length associated with the lens element to one or more pre-determined focal lengths.

64. The computer program product as claimed in claim 60, wherein the image is captured using a first image capture mode and a second image capture mode, and, wherein the pre-determined movement of the at least one of the lens element and the sensor element is performed during capture of the image using each of the first capture mode and the second capture mode.
